(19) United States
(12) Patent Application Publication
(10) Pub. No.: US 2007/0242465 A1
(43) Pub. Date: Oct. 18, 2007

(54) Reflector lamp

(75) Inventor: Andreas Nittke, Pietenfeld (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN, MUNCHEN (DE)

(21) Appl. No.: 11/797,812

(22) Filed: May 8, 2007

(30) Foreign Application Priority Data
Nov. 5, 2005 (DE) 10 2006 022 133.8

(51) Int. Cl. F21V 7/00

(52) U.S. Cl. 362/341

(57) ABSTRACT

A reflector lamp includes a reflector (1), a separate base (2) and an electric lamp (3), which is held in the reflector (1) and/or the base (2) by a holding device (5), the reflector (1) and the base (2) in the assembled state of the reflector lamp (I) forming a connection region (6), in which they are arranged such that they engage one inside the other, at least in regions, and are assembled without the use of an adhesive.

### TECHNICAL FIELD

The invention relates to a reflector lamp having a reflector, a separate base and an electric lamp, which is held in the reflector and/or the base by means of a holding device.

### PRIOR ART

Reflector lamps, in particular high-volt reflector lamps, are known in which the reflector and the base are designed to be integral and are realized, for example, in the form of all-glass reflectors. For example, such a reflector lamp by the Applicant is known under the name HALOPAR®. One advantage of these all-glass reflectors can be seen in that a relatively small amount of installation complexity is required. However, such reflector lamps are relatively difficult and complex to manufacture.

Furthermore, designs are known in which a glass reflector is assembled with a separate base, which is in the form of ceramic stone, by an unreleasable connection. The glass reflector and the ceramic stone are in this case connected by an adhesive joint, in particular cemented to one another. In an embodiment in which the reflector and the base are produced separately, a more cost-effective manufacture can be made possible. However, owing to the cementing of these two components, a higher degree of installation complexity is required. Owing to this plurality of manufacturing steps, and in particular owing to the additional process of cementing these two elements, a relatively expensive reflector lamp overall results.

### DESCRIPTION OF THE INVENTION

The present invention is therefore based on the object of developing a reflector lamp of the generic type such that it can be manufactured in a cost-effective manner and makes little installation complexity possible.

This object is achieved by a reflector lamp having the features as claimed in patent claim 1.

A reflector lamp according to the invention comprises a reflector and a base, the reflector and the base being formed as separate elements. Furthermore, the reflector lamp has at least one electric lamp, which is held in the reflector and/or the base by means of a holding device. The reflector and the base, in the assembled state of the reflector lamp, are arranged such that they form a common connection region, in which these two components are arranged such that they engage one inside the other, at least in regions, and are assembled or joined without the use of an adhesive.

As a result, a reflector lamp can be provided which can be manufactured in a cost-effective manner and can be installed relatively easily and with little complexity. In particular, the individual components of the reflector lamp can be joined with little complexity and with relatively few installation steps.

Advantageously, the reflector has a reflector neck, the connection region being formed between the reflector neck and the base. Preferably, the reflector and the base are joined with respectively facing end regions, with the result that the connection region is formed at these mutually facing end regions.

Preferably, the connection region is designed such that the reflector and the base are fixed in relation to one another at least in the direction of rotation about a longitudinal axis. Preferably, the connection region is designed such that the reflector and the base are also fixed in the direction of the longitudinal axis in relation to one another.

The reflector lamp can therefore be assembled, without the application of adhesive, in particular in the region in which the reflector and the base adjoin one another and preferably are in direct contact with one another. Joining without the use of an adhesive is understood to mean all types and procedures in which no adhesives or adhesive-like materials are used to fasten and/or fix and therefore also to mechanically connect these components to one another. An adhesive is therefore also understood to mean cement or the like and similar bonding materials.

Contact regions or contact faces between the reflector and the base are preferably structured such that they absorb torsional forces occurring when the assembled reflector lamp is installed in a fitting or holder of the reflector lamp. The connection region is in this case designed such that at least rotary movements, which occur, for example, when the reflector lamp is inserted into a fitting, can be absorbed and therefore the reflector lamp also remains compact and mechanically robust in the event of such force effects. The configuration can also be optimized so as to absorb tensile loads in the direction of the longitudinal axis.

The connection region preferably has engaging elements and engaging regions which are complementary thereto. Provision may be made for the engaging elements to be formed on one of the components, for example on the reflector and in particular on the reflector neck, whereas the complementary engaging regions are formed on the base and in particular on an end region of the base which faces the reflector. In particular when the region at which the reflector and the base are joined has a round or approximately round shape, in section, it is preferred if a plurality of engaging elements and engaging regions, which are complementary thereto, are formed. It is naturally also possible for provision to be made for at least one engaging element and at least one complementary engaging region, for example adjacent thereto, to be formed on the reflector. In a corresponding manner, in this case at least one engaging element and at least one engaging region, which is complementary thereto, can also be formed in the base. The reflector and the base are then assembled such that an engaging element of the reflector engages in a complementary engaging region in the base, and an engaging element of the reflector engages in an engaging region, which is complementary thereto, of the reflector. The engaging elements and the engaging regions can be arranged in alternate fashion.

Preferably, at least two engaging elements are formed which are formed on the reflector and/or on the base in radially peripheral fashion and preferably such that they are spaced apart from one another. Owing to such a design it is possible to achieve a situation in which the connection region, in the assembled state of the reflector lamp and in particular in the joined state of the reflector and the separate base, also enables centering of these components in relation to one another in a reliable manner. In particular in the plane which is oriented at right angles to the longitudinal axis of the reflector lamp, a relative movement of the reflector to the base can therefore be substantially prevented. Provision may also be made for the engaging elements to be arranged without any distance between them and to have a so-called serrated design.

Provision may also be made for the engaging elements to be designed to be offset inwards in a radial direction. The engaging elements and also the engaging regions are therefore no longer formed on the outer surface of the reflector and the base. Provision may preferably be made for the engaging regions to be formed in an at least partially peripheral web. This web is arranged such that it is offset inwards preferably in a radial direction in comparison to the outer edge and therefore to the outer surface of the reflector and/or the base. In this case, provision may be made for the web to be surrounded peripherally by a planar supporting region. In this case, the supporting region is in the form of a planar supporting region, particular in a plane which is arranged vertically with respect to the longitudinal axis of the reflector lamp. In this configuration, a protective measure can also be provided by virtue of the fact that it is not possible to gain access in the connection region to the interior of the reflector lamp and therefore also to the electric lamp contained therein. This ensures protection against electric shock and protection of the eyes.

The connection region may also be in the form of a plug-type connection. For example, the engaging elements may be in the form of pins or pin-like elements, which engage in or are plugged into cutouts or holes, which represent the engaging regions.

Advantageously, the engaging elements and the engaging regions are arranged completely peripherally and preferably equidistantly with respect to one another.

The base and the reflector are held together, at least in the direction of the longitudinal axis of the reflector lamp, by the electric lamp fixed in the reflector and/or the base. Owing to the fact that this electric lamp is fixed, as a result fixing of the reflector and the base in relation to one another in the longitudinal direction can also be made possible. The positioning of the components can be made possible thereby with little complexity and substantially without any additional parts or aids.

Provision may also be made for the base and the reflector to be held together, at least in the direction of the longitudinal axis of the reflector lamp, by fixed power supply lines of the electric lamp. Preferably, in this case the base has contact pins, into which the power supply lines of the electric lamp are passed. These power supply lines, which are also referred to as lead-in wires, are plugged into the contact pins and then fixedly crimped in these contact pins. In particular when the lamp is fixed in the reflector by means of the holding device and power supply lines are fixed in the contact pins of the base, the base and the reflector can be held together reliably and stably in the longitudinal direction of the reflector lamp. In this case, tensile and torsional forces can also be absorbed without the reflector lamp becoming mechanically unstable.

Provision may also be made for the holding device with which the electric lamp is held in the reflector and/or the base to join the base and the reflector to one another in a mechanically stable manner. The holding device can in this case be correspondingly designed and have corresponding parts, which can be reshaped by an installation process, for example, and, as a result, make it possible to produce the mechanical connection between the base and the reflector for stable holding purposes at least in the longitudinal direction.

The holding device may be formed by a mount disk. The electric lamp can be plugged into said mount disk and held stably thereby. Provision may also be made for the reflector to have a bottom region, in which two continuous holes are formed, through which the power supply lines of the electric lamp are plugged into the contact pins, which are formed in the base, and are then fixedly crimped in the contact pins.

Provision may also be made for a further element to be introduced in the connection region between the reflector and the base, with the result that the reflector and the base are arranged such that they are not directly adjacent to one another. In particular, this can take place when the reflector and the base are formed from glass.

The power supply lines may be designed to be elastic, at least in regions, such that a spring element is formed, at least in regions.

The reflector and the base can be releasably connected to one another, at least in the connection region. When dismantling them, the reflector and the base can then be separated from one another without being destroyed.

The base may be in the form of a bayonet-type base or else in the form of a screw-type base. Furthermore, in addition to the already mentioned material design consisting of glass, the base may also be formed from ceramic or plastic. Given a design consisting of glass, a hard glass may possibly be provided, depending on the thermal load. Another electrically insulating material may also be provided for the base.

The electric lamp may be in the form of an arc lamp and in particular be a discharge lamp or an incandescent lamp. However, provision may also be made for the electric lamp to be in the form of a light-emitting diode. Owing to the use of an arc lamp, which does not require any external fuse protection and therefore does not require any fuse wires for disconnecting the arc, it is preferably possible to hold the two components, the reflector and the base, together by the arc lamp or its power supply lines.

### BRIEF DESCRIPTION OF THE DRAWINGS

Exemplary embodiments of the present invention will be explained in more detail below with reference to schematic drawings, in which:

FIG. 1 shows an exploded illustration of a first exemplary embodiment of a reflector lamp according to the invention;

FIG. 2 shows an exploded illustration in which elements of a reflector lamp according to the invention and in accordance with a further exemplary embodiment are shown; and

FIG. 3 shows an exploded illustration of subelements of a reflector lamp according to the invention and according to a third exemplary embodiment.

### PREFERRED EMBODIMENT OF THE INVENTION

In the figures, identical or functionally identical elements are provided with the same reference symbols.

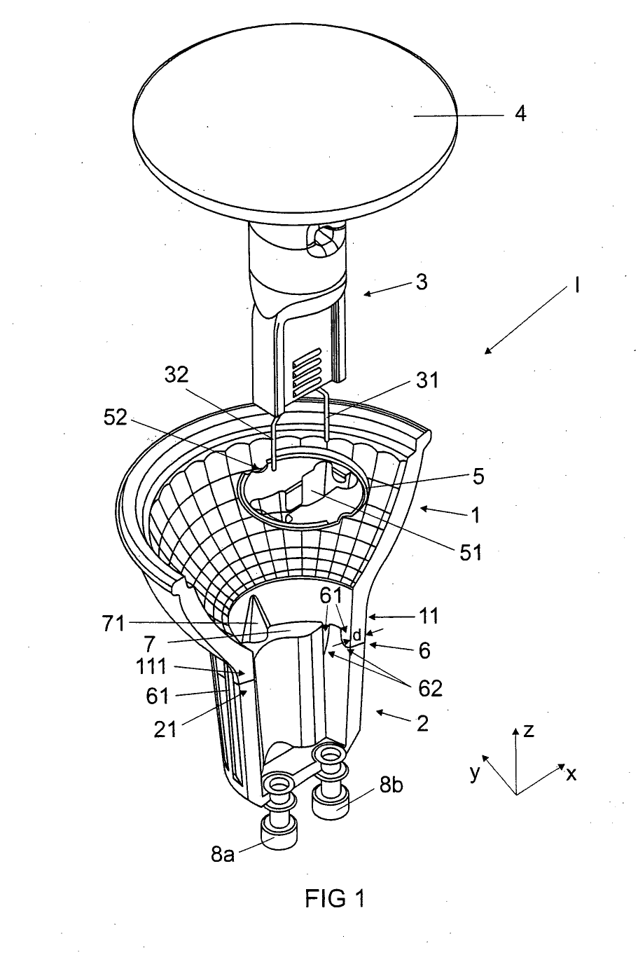

FIG. 1 shows a perspective exploded illustration of a reflector lamp I, in which a reflector 1 and a base 2 are also shown in a sectional illustration. The reflector 1 and the base 2 are separate components of the reflector lamp I and, in the assembled state of the reflector lamp I, are arranged such that they engage one inside the other, at least in regions.

An electric lamp 3, which in the exemplary embodiment is in the form of an arc lamp and represents a discharge lamp, is arranged in the reflector lamp I.

The reflector 1 is covered by a transparent covering element 4. This covering element 4 may be formed from glass or plastic and may represent a flat disk. It is likewise also possible for provision to be made for this covering element 4 to be curved, at least in regions, or to be instead or in addition designed as an optical element, for example a lens. The reflector lamp I may, however, also be formed without this covering element 4.

The electric lamp 3 is held in the reflector 1 and the base 2 by a holding device 5, which, in the exemplary embodiment, is in the form of a lamp mount disk. The holding device 5 has a continuous cutout 51 for this purpose, through which cutout a lower region of the electric lamp 3 is plugged, the cutout 51 being designed for the accurately fitting insertion of the electric lamp 3. As a result, stable holding and fixing of the electric lamp 3 can be made possible.

In the assembled state of the reflector lamp I, the reflector 1 and the base 2 in the exemplary embodiment are arranged directly adjacent to one another and form a connection region 6, at which these two components bear against one another. As can be seen in the illustration in FIG. 1, the reflector 1 has a reflector neck 11, which in turn has an end region 111, which corresponds in terms of shape and dimensions to the base 2. In particular, the dimensions of this end region 111 are designed such that they correspond to the dimensions of the end region 21, which faces the reflector neck 11, of the base 2. In the assembled state, the reflector 1 and the base 2 are therefore joined onto one another substantially with an accurate fit and flush.

In the exemplary embodiment, the connection region 6 has a plurality of engaging elements 61 and engaging regions 62, which are designed to be complementary thereto. The engaging elements 61 are in this case formed on the end region 111 of the reflector neck 11 and, in the exemplary embodiment, are in the form of arcuate elements, which are oriented downwards in the direction of the base 2. The engaging regions 62, which are designed to be complementary thereto, are formed in the base 2. In the exemplary embodiment, the plurality of engaging elements 61 and the engaging regions 62 are arranged radially peripherally and are formed substantially equidistantly with respect to one another. As can be seen in the assembled representation of the reflector 1 and the base 2 shown in FIG. 1, these two elements rest flat one on top of the other at the end regions 21 of the base 2 and the end region 111 of the reflector neck 11 via a corresponding contact face, which is formed in the connection region 6, the join between these two parts 1 and 2 being formed without the use of an adhesive in this connection region.

The embodiment shown of the connection region 6 and in particular the engaging elements 61 and the engaging regions 62 means that, in the assembled state of the reflector 1 and the base 2, these two parts are arranged in positionally stable fashion in a plane (x-y plane) at right angles to the longitudinal axis (z direction) of the reflector lamp I. Owing to this configuration of the connection region 6, it is possible to prevent these two parts from sliding in relation to one another in this x-y plane. The connection region 6 thereby also acts at the same time as a fixing and centering region. Furthermore, this design of the connection region 6 also ensures that the reflector 1 and the base 2 engage in one another with an accurate fit.

Owing to the toothed, adhesive-free connection between the reflector 1 and the base 2, it is furthermore possible to ensure that torsional forces which occur when the reflector lamp I is inserted into a holder or fitting can also be absorbed without the reflector lamp I becoming mechanically unstable and the reflector 1 and the base 2 sliding in relation to one another. The reflector lamp I can therefore be rotated without any problems about its longitudinal axis and inserted reliably into a fitting.

In the exemplary embodiment, the base 2 is in the form of a bayonet-type base and has two contact pins 8a and 8b at a lower end, which pins can be inserted into a fitting.

Power supply lines 32 or 31 of the electric lamp 3 can be inserted into these contact pins 8a and 8b, respectively. In the assembled state of the lamp I, the holding device 5 then rests on a web 7. In order to be able to prevent this holding device 5 from being rotated, a positioning region 71, in which a complementary cutout 52 of the holding device 5 engages, is also formed here.

The arc lamp or-the electric lamp 3 can, however, also be held such that a bottom region with two cutouts or holes is formed in the reflector 1, through which cutouts or holes the lead-in wires or power supply lines 31 and 32 are plugged into the contact pins 8a and 8b and then fixedly crimped in, these contact pins 8a and 8b.

In the exemplary embodiment, the reflector 1 and the base 2 are held together, in the direction of the longitudinal axis of the reflector lamp I, by the fixing arrangement of the electric lamp 3 and the fixed power supply lines 31 and 32. This support in the direction of the longitudinal axis is in this case designed such that tensile forces in this direction of the longitudinal axis can be absorbed without any problems. The fixed fixing and stable holding together of the reflector 1 and the base 2 is therefore also ensured in this direction of the longitudinal axis.

The configuration of the connection region 6 and in particular the embodiment of the engaging elements 61 and the engaging regions 62 is merely exemplary and can be configured in a variety of ways. The engaging elements 61 may also be in the form of saw teeth or peaks. It is essential that in this case the reflector 1 and the base 2 are designed to engage one inside the other and that adhesive-free assembly of these two parts is ensured.

Provision may also be made for only two of these engaging elements 61 and the complementary engaging regions 62 to be formed. Given such a low number of engaging elements 61 and engaging regions 62, it is then advantageous that they are likewise designed to be spaced apart from one another on the radial supporting face. Furthermore, in such a configuration, it is advantageous if the engaging elements 61 and the engaging regions 62 are designed to taper outwards in the radial direction or inwards in the radial direction over the thickness d of the end region 111, which also represents a thickness d of the base 2 in the end region 21. This means that, for example, the engaging regions 62 can become narrower, for example, in the radial direction towards the longitudinal axis of the reflector lamp I. For example, in this case a shape in the form of a funnel may be provided in the x-y plane. As a result, secure fixing and centering of the reflector 1 in relation to the base 2 in the x-y plane can be achieved with only two engaging elements. Provision may also be made for the engaging regions 62 and the engaging elements 61 to extend in the radial direction partially over the thickness d and for the rest of the region of the material up to the entire thickness d to be in the form of a stop region. As a result, on the one hand, a rotation about the longitudinal axis can be prevented and sliding in the radial direction can be avoided. The engaging elements 61 and the engaging regions 62 may also have a stepped design.

Provision may likewise also be made for at least two pins to be arranged on the reflector 1 and in particular on the reflector neck 11, which pins can be inserted into corresponding holes or drilled holes in the end region 21 of the base 2. This also makes it possible for an adhesive-free and interengaging connection between these two parts to be formed. These embodiments mentioned here of the connection region 6 are also merely exemplary and are not to be considered exhaustive.

This design is particularly suitable when the arc lamp or the electric lamp 3 is formed without external fuse wires, which are necessary in particular for disconnecting arcs.

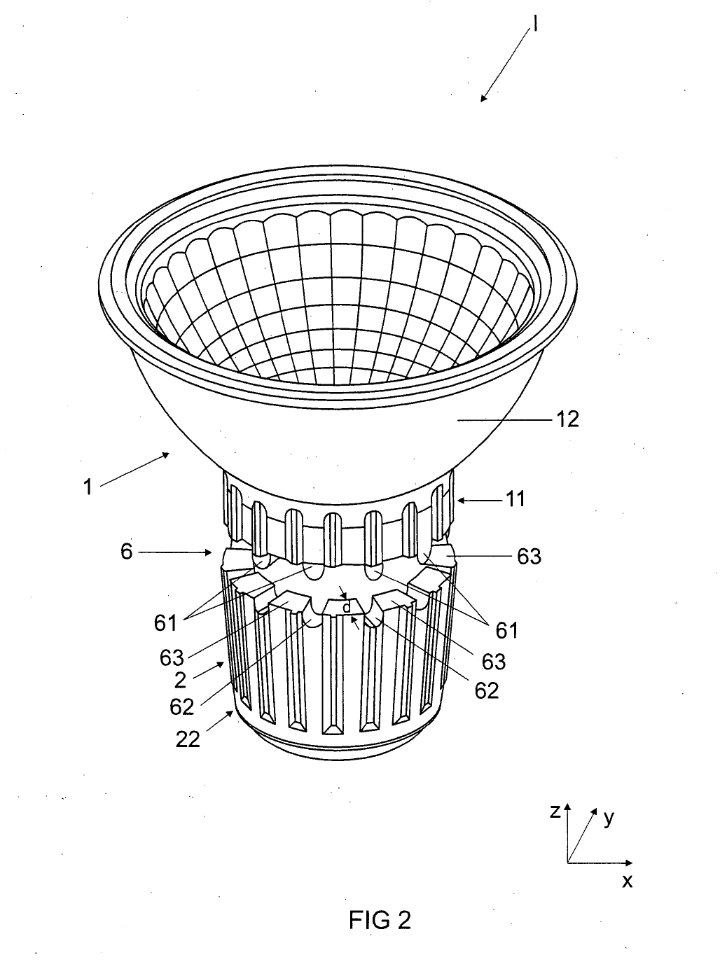

FIG. 2 shows a perspective illustration of the reflector 1 and the base 2, which represent a connection region 6, as is formed in the embodiment shown in FIG. 1. The plurality of engaging elements 61, which are arcuate and rounded-off, are illustrated. Furthermore, the engaging regions 62, which are in the form of grooves in the base 2, are also shown. Furthermore, planar contact faces and supporting regions 63 are provided at which the reflector neck 11 and the base 2 likewise bear directly against one another. Adhesive-free contact is also produced on these supporting regions 63. In the exemplary embodiment shown, the reflector 1 is separated from the base 2 in such a way that the reflector neck 11, with its shape which is substantially similar to the end region 21, rests on this base 2.

Provision may also be made for the connection region 6 to directly adjoin the conical part 12 of the reflector 1 and for the reflector 1 to therefore have no reflector neck 11. Provision may likewise also be made for the connection region 6 to be formed even closer to the lower end 22 and therefore closer to the contact pins 8a and 8b (FIG. 1). Depending on the corresponding configuration of the reflector lamp I, the connection region 6 can therefore be formed at different positions.

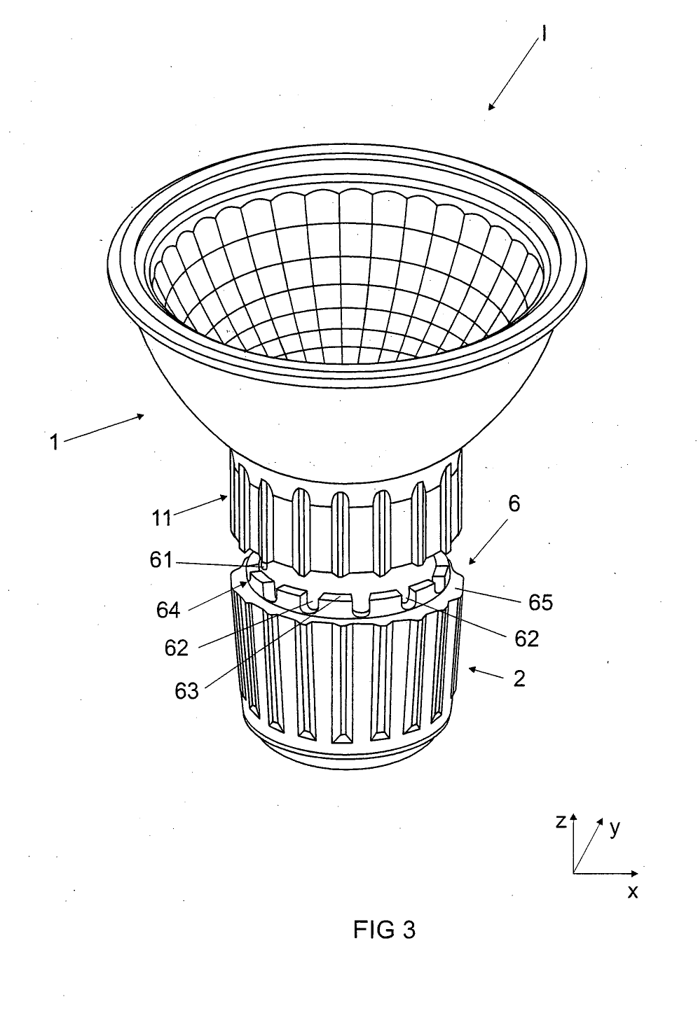

A further embodiment of a connection region 6 is shown in the perspective exploded illustration in FIG. 3. In this case, too, only the reflector 1 and the base 2 are illustrated, in this embodiment the connection region 6 in turn having a plurality of engaging elements 61 and engaging regions 62. The engaging regions 62 are in this embodiment offset inwards in the radial direction and formed in a raised, completely peripheral web 64. This web 64 is peripherally surrounded by a planar supporting face or supporting region 65. In this configuration, the reflector neck 11 also rests on the supporting region 65, in addition to the planar supporting faces 63. In this configuration, reliable protection against electric shock and protection of the eyes can therefore also be ensured into the interior of the reflector lamp I. Also, in the case of manufacturing tolerances which may occur, it is therefore not possible to enter the interior of the reflector lamp I through the engaging regions 62, as a result of which increased safety in terms of electric shocks can be ensured.

In addition to the embodiments shown in FIG. 1 to FIG. 3 of the connection region 6 and therefore of the adhesive-free interengaging joining of the reflector 1 and the base 2, provision may also be made for them to be connected by means of a latching apparatus. Owing to a latching apparatus such as this, in addition it is then also possible to achieve a situation in which the reflector 1 and the base 2 are held together in a force-fitting and interlocking manner without any additional aids, for example a holding device 5, even in the longitudinal direction (z direction). For example, such a latching apparatus may therefore be provided with a bayonet-type closure. Such a latching apparatus may also be designed such that, in the latched state, a rotary movement of the reflector 1 in relation to the base 2 is no longer possible in the x-y plane.

1. A reflector lamp having a reflector (1), a separate base (2) and an electric lamp (3), which is held in the reflector (1) and/or the base (2) by means of a holding device (5), characterized in that the reflector (1) and the base (2) in the assembled state of the reflector lamp (I) form a connection region (6), in which they are arranged such that they engage one inside the other, at least in regions, and are assembled without the use of an adhesive.

2. The reflector lamp as claimed in claim 1, characterized in that the reflector (1) has a reflector neck (11), and the connection region (6) is formed between the reflector neck (11) and the base (2).

3. The reflector lamp as claimed in claim 1, characterized in that the connection region (6) is formed at mutually facing end regions (111, 21) of the base (2) and of the reflector (1).

4. The reflector lamp as claimed in claim 1, characterized in that the connection region (6) is designed such that the reflector (1) and the base (2) are fixed in relation to one another at least in the direction of rotation about a longitudinal axis of the reflector lamp (I).

5. The reflector lamp as claimed in claim 1, characterized in that the connection region (6) has engaging elements (61) and engaging regions (62) which are complementary thereto.

6. The reflector lamp as claimed in claim 5, characterized in that at least two engaging elements (61) are formed which are formed on the reflector (1) and/or on the base (2) in radially peripheral fashion and such that they are spaced apart from one another.

7. The reflector lamp as claimed in claim 5, characterized in that the engaging elements (61) are designed to be offset inwards in the radial direction.

8. The reflector lamp as claimed in claim 5, characterized in that at least one engaging region (62) is formed in an at least partially peripheral web (64).

9. The reflector lamp as claimed in claim 8, characterized in that the web (64) is surrounded peripherally by a planar supporting region (65).

10. The reflector lamp as claimed in claim 5, characterized in that the engaging elements (61) and the engaging regions (62) are arranged entirely peripherally and equidistantly.

11. The reflector lamp as claimed in claim 1, characterized in that the base (2) and the reflector (1) are held together, at least in the direction of the longitudinal axis of the reflector lamp (I), by the lamp fixed in the reflector (1) and/or the base (2).

12. The reflector lamp as claimed in claim 1, characterized in that the base (2) and the reflector (1) are held together, at least in the direction of the longitudinal axis of the reflector lamp (I), by fixed power supply lines (31, 32) of the electric lamp (3).

13. The reflector lamp as claimed in claim 1, characterized in that the holding device is a mount disk (5).

14. The reflector lamp as claimed in claim 1, characterized in that the base (2) is in the form of a screw-type base or a bayonet-type base.

15. The reflector lamp as claimed in claim 1, characterized in that the base (2) is formed at least partially from glass or ceramic or plastic.

16. The reflector lamp as claimed in claim 1, characterized in that the electric lamp (3) is in the form of an arc lamp, in particular a discharge lamp or incandescent lamp, or in the form of a light-emitting diode.

17. The reflector lamp as claimed in claim 2, characterized in that the connection region (6) is formed at mutually facing end regions (111, 21) of the base (2) and of the reflector (1).

18. The reflector lamp as claimed in claim 2, characterized in that the connection region (6) is designed such that the reflector (1) and the base (2) are fixed in relation to one another at least in the direction of rotation about a longitudinal axis of the reflector lamp (I).

19. The reflector lamp as claimed in claim 1, characterized in that the connection region (6) is designed such that the reflector (1) and the base (2) are fixed in relation to one another at least in the direction of rotation about a longitudinal axis of the reflector lamp (I).

20. The reflector lamp as claimed in claim 2, characterized in that the connection region (6) has engaging elements (61) and engaging regions (62) which are complementary thereto.
